(19) United States
(12) Patent Application Publication
(10) Pub. No.: US 2010/0135644 A1
(43) Pub. Date: Jun. 3, 2010

(54) PHOTOGRAPHING APPARATUS AND METHOD OF CONTROLLING THE SAME

(75) Inventor: Mineki Taoka, Yokohama (JP)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/625,724

(22) Filed: Nov. 25, 2009

(30) Foreign Application Priority Data
Nov. 28, 2008 (JP) 2008-305453

(51) Int. Cl. H04N 5/00

(52) U.S. Cl. 386/120; 386/E05.001

(57) ABSTRACT

A photographing apparatus and a method of controlling the photographing apparatus for restricting bandwidth use of a memory in the photographing apparatus when a still image is captured during recording a motion picture. The method including outputting image data from an imaging device; interpolating the image data and storing the result as motion picture data in a memory; encoding the motion picture data in the memory; determining if a request to take a still image is received; when a request for a still image is received, substantially stopping the encoding of the motion picture data in the memory while continuing the outputting, interpolating and storing, and storing the image data in the memory as the still image; and after storing the still image is complete, restarting the encoding of the motion picture data in the memory.

### CROSS-REFERENCE TO RELATED PATENT APPLICATION

This application claims the benefit of Japanese Patent Application No. 2008-305453, filed on Nov. 28, 2008 in the Japanese Intellectual Property Office, the entire contents of which is incorporated herein by reference.

### BACKGROUND OF THE INVENTION

1. Field of the Invention

The present invention relates to a photographing apparatus and a method of controlling the photographing apparatus.

2. Description of the Related Art

Recently, high speed and high pixel count photographing has been performed by photographing apparatuses such as high speed digital cameras. However, in portable photographing apparatuses, there is a limitation in increasing an operating frequency of a large scale integration (LSI) due to a limitation in power consumption. Accordingly, when designing a system in which still images may be captured while recording a motion picture, it is difficult to store the still images captured while recording the motion picture in a memory because a bandwidth of the memory used in storing image data is limited.

### SUMMARY OF THE INVENTION

The present invention provides a photographing apparatus and a method of controlling the photographing apparatus that may restrict the accessible bandwidth of a memory in the photographing apparatus used when still images are captured during recording of a motion picture.

According to an aspect of the present invention, there is provided a photographing apparatus including: a motion picture data encoder for encoding image data of a motion picture that is output from an imaging device by a frame unit when recording the motion picture; a memory for storing image data of a still image output from the imaging device; and a controller for storing the image data of the still image in the memory after stopping the encoding of the image data of the motion picture, when the still image is captured during recording of the motion picture, wherein the controller restarts the encoding of the image data of the motion picture from an image frame at which the encoding is stopped during the capturing of the still image, and when the recording of the motion picture restarts after the capturing of the still image, a bayer interpolation unit interpolates the image data output from the imaging device when recording the motion picture, the memory includes buffers for the motion picture that store the image data after being interpolated, and the motion picture data encoder encodes the image data of the motion picture after being interpolated. Therefore, encoding of the motion picture data is stopped when capturing still images during recording the motion picture, and accordingly, an accessible bandwidth of the memory in the photographing apparatus may be limited.

The photographing apparatus may further include a still image data encoder encoding the image data of the still image, and the controller may control the still image data encoder to encode the image data of the still image after finishing the encoding of the image data of the motion picture, which is stopped due to the capturing of the still image. Therefore, there is no need to access the memory for encoding the still image data during recording the motion picture, and the accessible bandwidth of the memory may be ensured.

The memory may store the image data of the still image output from the imaging device as bayer data. Therefore, there is no need to access the memory for encoding the still image data during recording the motion picture, and the accessible bandwidth of the memory may be ensured.

The memory may include buffers for the motion picture that correspond to the number of image frames of the still images captured during recording of the motion picture. Therefore, the motion picture data, encoding of which is temporarily stopped due to the capturing of still images, may be temporarily stored in the buffers for the motion picture.

The memory may include buffers for the still images that correspond to the number of image frames of the still images captured during the recording of the motion picture. Therefore, the image data of still images captured during recording of the motion picture may be temporarily stored in the buffers for the still images.

According to an aspect of the present invention, there is provided a method of controlling a photographing apparatus, the method including: outputting image data from an imaging device; interpolating the image data and storing the result as motion picture data in a memory; encoding the motion picture data in the memory; determining if a request to take a still image is received; when a request for a still image is received, substantially stopping the encoding of the motion picture data in the memory while continuing the outputting, interpolating and storing, and storing the image data in the memory as the still image; and after storing the still image is complete, restarting the encoding of the motion picture data in the memory.

The method may include encoding the still image after finishing the encoding of delayed motion picture data.

Storing the data output from the imaging device in the memory as the still image may include storing the data output from the imaging device in the memory as the still image in bayer data.

The memory may include buffers large enough for motion picture data that can be stored during the storing of a predetermined number of still images.

The memory may include buffers large enough for a predetermined number of still images that can be stored during the capturing of the motion picture.

Restarting may include restarting the encoding of the motion picture data in the memory at the same rate of compression as before the still image was captured.

The method may include compressing the still image with jpeg after the restarting the encoding of the motion picture data in the memory.

According to an aspect of the present invention, there is provided a photographing apparatus including: an imaging device configured to output image data; a camera processor, configured to pass the image data to a bayer unit for capturing motion picture data when taking a moving picture, and configured to both pass the image data to a bayer unit and store the image data in a memory when taking a moving picture and capturing a still image; the bayer unit, configured to interpolate the image data and store the result as motion picture data in the memory; an mpeg encoder, configured to encode motion picture data stored in the memory; a host CPU, configured to determine if a request to take a still image is received, and when a request for a still image is received, configured to substantially stop the mpeg encoder from encoding the motion picture data, and configured to control the imaging device to continue to output image data, and configured to control the camera processor to pass the image data to the bayer unit and to store the image data in the memory as the still image, and configured to control the bayer unit to interpolate the image data and store the result as motion picture data, and configured to after storing the still image is complete, to control the mpeg encoder to continue to encode the motion picture data.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an example of a photographing apparatus according to an embodiment of the present invention;

FIG. 2 is a diagram showing examples of processes of the photographing apparatus of FIG. 1;

FIG. 3 is a flowchart illustrating an example of a process of capturing still images during recording of a motion picture according to an embodiment of the present invention; and

FIG. 4 is a flowchart illustrating an example of a process of terminating recording of a motion picture according to an embodiment of the present invention.

### DETAILED DESCRIPTION OF THE INVENTION

Therefore, there is a need in the art for an apparatus and method of controlling a photographing apparatus. The method including outputting image data from an imaging device; interpolating the image data and storing the result as motion picture data in a memory; encoding the motion picture data in the memory; determining if a request to take a still image is received; when a request for a still image is received, substantially stopping the encoding of the motion picture data in the memory while continuing the outputting, interpolating and storing, and storing the image data in the memory as the still image; and after storing the still image is complete, restarting the encoding of the motion picture data in the memory.

Hereinafter, the present invention will be described in detail by explaining embodiments of the invention with reference to the attached drawings. Like reference numerals in the drawings denote like elements.

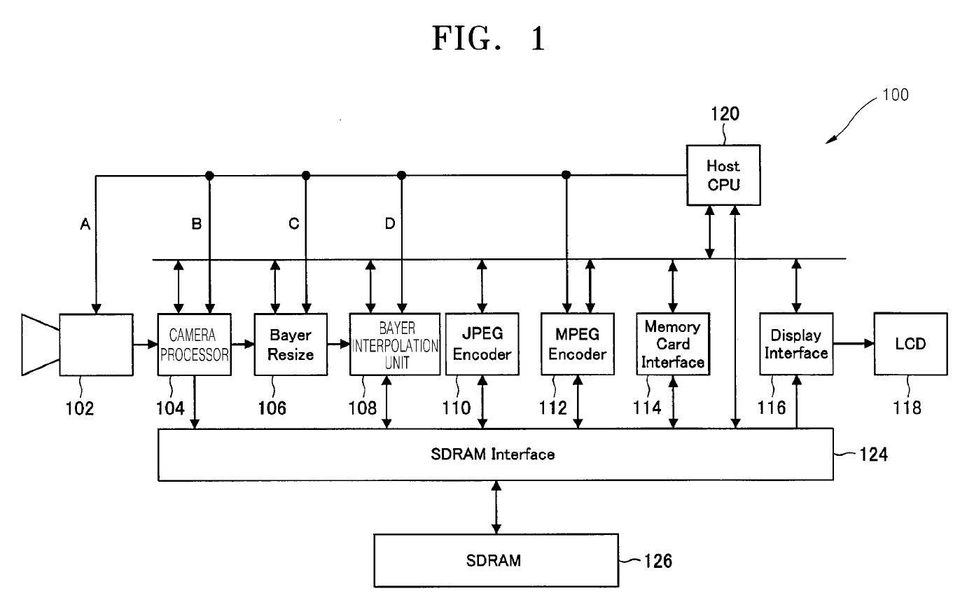

FIG. 1 is a block diagram of an example of a photographing apparatus 100. The photographing apparatus 100 includes a camera unit 102, a camera processor 104, a bayer resize unit 106, a bayer interpolation unit 108, a joint photographic experts group (JPEG) encoder 110, a motion picture experts group (MPEG) encoder 112, a memory card interface 114, a display interface 116, a liquid crystal display (LCD) 118, a host central processing unit (CPU) 120, a synchronous dynamic random access memory (SDRAM) interface 124, an SDRAM (memory unit) 126.

The camera unit 102 includes a lens optics and an imaging device. The lens optics may have an optical zooming function that varies a focal distance by moving a lens group. In addition, the imaging device may include a sensor such as a charge coupled device (CCD) or a complementary metal oxide semiconductor (CMOS).

In the example camera unit 102, an image of a subject is focused on an imaging surface of the imaging device, and the imaging device obtains an image signal. The image signal obtained by the imaging device is output as bayer pattern data and transmitted to the camera processor 104. The camera processor 104 processes the bayer pattern data, and performs detection of in-focus information, acquisition of automatic exposure (AE) information, compensation of omitted data, and compensation of shading in the lens.

When the image of the subject is recorded as a motion picture, the bayer pattern data processed by the camera processor 104 is transferred to the bayer resize unit 106 by a frame unit. The bayer resize unit 106 performs compressing or an interpolating on the bayer pattern data to convert a resolution of the bayer pattern data into, for example, a high definition (HD) level (1920×1080 pixels or 1280×720 pixels). The bayer pattern data output from the bayer resize unit 106 is input into the bayer interpolation unit 108. The bayer interpolation unit 108 converts the bayer pattern data into image data of YCbCr format, and transmits the image data to the SDRAM 126 via the SDRAM interface 124 to accumulate the signal in the SDRAM 126. The image data of YCbCr format is encoded into MPEG format data in the MPEG encoder 112, and the encoding result is transmitted to the memory card interface 114 so as to be recorded in a memory card connected to the memory card interface 114. In addition, the bayer interpolation unit 108 may perform a series of developing processes including a white balance process, a noise removal, and brightness and color compensation, as well as the bayer interpolation for converting the bayer pattern data into the image data of YCbCr format.

When the image of the subject is captured as a still image, the bayer pattern data processed in the camera processor 104 is transferred to the SDRAM 126 via the SDRAM interface 124, and accumulated in the SDRAM 126. When the still image is captured during the recording of the motion picture, bayer image data that corresponds to a frame of the motion picture transmitted from the camera processor 104 to the bayer resize unit 106 is transferred to the SDRAM 126. The bayer image data transferred to the SDRAM 126 is converted into image data of YCbCr format by the bayer interpolation unit 108, and stored in the SDRAM 126. The image data of YCbCr format is encoded into JPEG format data, and the encoding result is transmitted to the memory card interface 114 to be recorded in the memory card connected to the memory card interface 114.

In the example illustrated in FIG. 1 the host CPU 120 controls operations of the components. That is, the camera unit 102, the camera processor 104, the bayer resize unit 106, the bayer interpolation unit 108, the JPEG encoder 110 and the MPEG encoder 112 are controlled by the host CPU 120. In addition, the LCD 118 is connected to the display interface 116 to display captured images.

In the photographing apparatus 100, two kinds of operations may be performed in a motion picture recording mode. In a first operation, when image data is output from the imaging device, a process such as combining or removing of pixel signals is performed to output the image data having a reduced number of pixels. In this case, the bayer resize unit 106 may not operate, or may convert the resolution of the image data using a low compression rate. In addition, after performing the bayer interpolation on the image data in the bayer interpolation unit 108, the image data is encoded into MPEG format data in the MPEG encoder 112.

In a second operation, image data is output from the imaging device having a non-reduced number of pixels. In this case, the bayer resize unit 106 may convert the resolution of the image data using a relatively high compression rate compared with that of the first operation. The first operation, that is, outputting the highly compressed image data from the imaging device, is advantageous in view of reducing power consumption. However, the second operation is performed when a still image and a motion picture are recorded simultaneously.

However, when a still image is desired to be captured during recording of a motion picture, the processes such as the bayer interpolation and the encoding of motion picture data into MPEG format data with the storing of image data having a non-reduced number of pixels in the SDRAM 126 are performed in parallel, and thus the SDRAM 126 is accessed greatly. For example, memory such as the SDRAM 126 storing image data has a frequency of about 166 MHz, and has a bus width of about 32 bits as an upper limit. In this case, in a device having limited power consumption, in particular, a portable device, a clock frequency may not be increased, and thus accessible frequency band (bandwidth) of the SDRAM 126 may be insufficient. In particular, the MPEG encoding which is performed during the recording of the motion picture, includes the operation performing the compression and encoding of image data by using correlation between a plurality of image data of a plurality of frames, and accordingly, uses a large part of the bandwidth of the SDRAM 126. In addition, when the image data having a non-reduced number of pixels is output from the imaging device, about 6 megapixels to about 10 megapixels of image data is accumulated in the SDRAM 126 within a time period of about 1/30^{th} of a second or about 1/60^{th} of a second. When a still image is captured during recording of a motion picture, a clock frequency that is twice that in the general photographing mode would be required.

In the present embodiment, when capturing of a still image during recording of a motion picture, image data of the still image having a non-reduced number of pixels is output from the imaging device. In addition, the camera processor 104 transmits the image data to the SDRAM 126 to store the image data having the non-reduced number of pixels in the SDRAM 126. At the same time, the camera processor 104 also outputs the image data having the non-reduced number of pixels to the bayer resize unit 106.

The bayer resize unit 106 converts the resolution of the image data to resize the image data to the size of the motion picture. The bayer interpolation unit 108 converts the image data, the resolution of which is converted, into image data of YCbCr format. The SDRAM 126 secures a storage region corresponding to one frame of the motion picture for the image data of YCbCr format additionally, and stores the image data of the YCbCr format in the storage region.

In addition, according to the present embodiment, the host CPU 120 instructs the MPEG encoder 112 to stop operating when the still image is captured. In embodiments, the MPEG encoder 112 may continue to operate at a much reduced rate so as not to interfere with the access to the memory. At this time, a buffer for input image frames of the motion picture is set to correspond to the number of the input frames of the motion picture plus one, and the image frame of the motion picture that (corresponds to the still image and) is not MPEG encoded is stored in the additional buffer. When the operation of the MPEG encoder 112 is stopped, sufficient bandwidth of the SDRAM 126 may be ensured, and image data having a non-reduced number of pixels transmitted from the camera processor 104 to the SDRAM 126 via the SDRAM interface 124 may be stored in the SDRAM 126.

After finishing the capturing of the still image, encoding of the image data of the motion picture to MPEG format data restarts from the point before the capturing of the still image in the MPEG encoder 112. In addition, operations of the components return to the motion picture photographing mode.

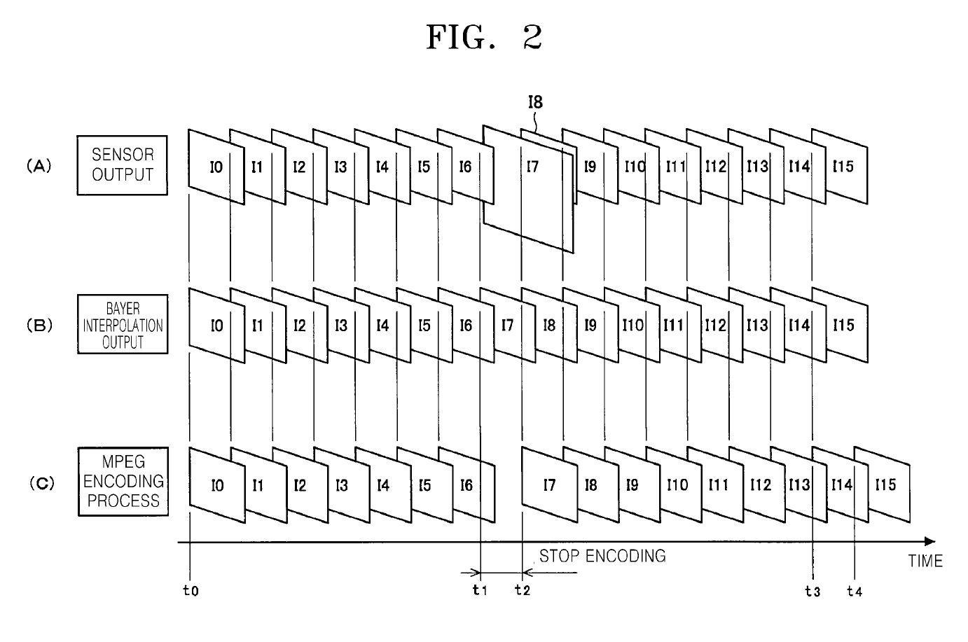

FIG. 2 is an example of a diagram showing the above processes. Here, row (A) represents image data output from the imaging device, row (B) represents the image data output from the bayer interpolation unit 108, and row (C) represents the image data encoded to MPEG format data by the MPEG encoder 112.

In FIG. 2, when recording a motion picture, frames 10 to 115 are successively captured, and the frame 17 is captured as a still image during recording of the motion picture. First, the recording of the motion picture starts at a time to. When the recording of the motion picture starts, image data of one frame is processed by the camera processor 104, interpolated by the bayer interpolation unit 108, and encoded to MPEG format data by the MPEG encoder 112 at substantially the same time as outputting the image data from the imaging device. Therefore, whenever the image data of one frame is output from the imaging device, the bayer interpolation and the MPEG encoding for a frame are performed.

In addition, when the frame 17 is captured at a time t1, the image data of the frame 17 having a non-reduced number of pixels is output from the imaging device. The image data of the frame 17 is stored in the SDRAM 126. In FIG. 2, only one frame of still image is captured, and thus only the image data of the frame 17 is directly stored in the SDRAM 126 among the image data of the frames 10 to 115. When the capturing of the still image is finished, the recording of the motion picture is started again, and then the image data of the frames 18 to 115 is output from the imaging device and interpolated.

The frames I0-I6 and I8-I15 of the motion picture are output from the imaging device in a state where a process such as combining or removing pixel signals is already performed with respect to the image data in the first operation previously described. Therefore, the image frames I0-I6 and I8-I15 of the motion picture are compressed to a size smaller than the image frame 17 of row (A) of FIG. 2. However, the image frames I0-I6 and I8-I15 of the motion picture may be output having the non-reduced number of pixels, such as the image data of the still image, according to the second operation.

The image data of the frame 17 is directly transmitted to the SDRAM 126, and at the same time, also transmitted to the bayer resize unit 106 and the bayer interpolation unit 108. At this time, the bayer resize unit 106 converts the resolution with the relatively high compression rate according to the above described second operation. Then, the image data of each of the frames I0-I15, including the image data of the frame 17, is transmitted to the bayer interpolation unit 108, and then interpolated in the bayer interpolation unit 108. In addition, the image data is output from the bayer interpolation unit 108 as image data of YCbCr format and stored in the SDRAM 126.

As shown in row (C) of FIG. 2, when the frame 17 is captured at the time t1, the encoding operation of the MPEG encoder 112 is stopped. In addition, after finishing the capturing of the frame 17, the MPEG encoding restarts at a time t2. Therefore, the MPEG encoding is not performed from the time t1 to the time t2.

After restarting the MPEG encoding, at the time t2, the MPEG encoding of a frame is performed whenever the image data of one frame is output from the imaging device. Therefore, the finishing point of the MPEG encoding is delayed by an amount corresponding to the number of still image frames. However, an increase in a frame buffer of the SDRAM 126 may be restricted by stopping the MPEG encoding. In addition, the MPEG encoding after restarting may be performed at the same speed as before stopping the encoding, and thus accessed bandwidth of the SDRAM 126 is not increased. Therefore, when the accessible bandwidth of the memory is limited like in the portable device, the system may be configured with a minimum number of system clocks, and power consumption may be greatly reduced.

In FIG. 2, one frame of still image is captured, and the MPEG encoding is finished at a time t4, wherein the time t4 is later than a time t3 when the recording is finished and wherein the difference between time t3 and time t4 is as much as a stopped period of the encoding (time period from the time t1 to the time t2). In general, since a relatively low number of still image frames are captured during recording of the motion picture, the above delay does not affect the overall photographing operation. For example, in the imaging device having a reading speed of about 30 fps (frame per second), the finishing point of the MPEG encoding is delayed about 0.03 second for each frame of still image captured. Even if three frames of still images are captured, the finishing point of the MPEG encoding is delayed by about 0.1 second. After finishing the MPEG encoding of the image data of the motion picture, the image data of the still image captured at the time t1 is encoded by the JPEG encoder 110. As described above, since the encoding of the motion picture data is stopped during the capturing of the still image and the encoding of the still image is performed after finishing the recording operation, the accessible bandwidth of the SDRAM 126 may be restricted to a minimum, and the still image and the motion picture may be captured simultaneously.

As described above, since the MPEG encoding is stopped when the still image is captured, the bandwidth for accessing the SDRAM 126 may be ensured. In addition, the image data of the still image may be directly stored in the SDRAM 126. Therefore, the image data of the still image, which is captured during recording of the motion picture, may be accumulated in the SDRAM 126 with the minimum number of system clocks.

In addition, since the MPEG encoding is not performed when the image data of the still image is output from the imaging device, the increase in the frame buffer for the motion picture may be restricted. For example, when the still image of one frame is captured during recording of the motion picture, the motion picture for one frame is in a standby mode for the MPEG encoding. Therefore, the SDRAM 126 ensures additional buffer for one input frame of the motion picture, and at the same time, the SDRAM 126 ensures the buffer for the still image of one frame. Therefore, the capacity of the buffer required by the capturing of the still image may be sufficient. Likewise, when a plurality of frames of a plurality of still images are captured during recording of the motion picture, the SDRAM 126 may ensure additional buffer for the frames of the motion picture, the number of which is the same as number of the frames of the still images, and the buffer for the still image data. Therefore, increase in the buffer capacity in the SDRAM 126 may be restricted.

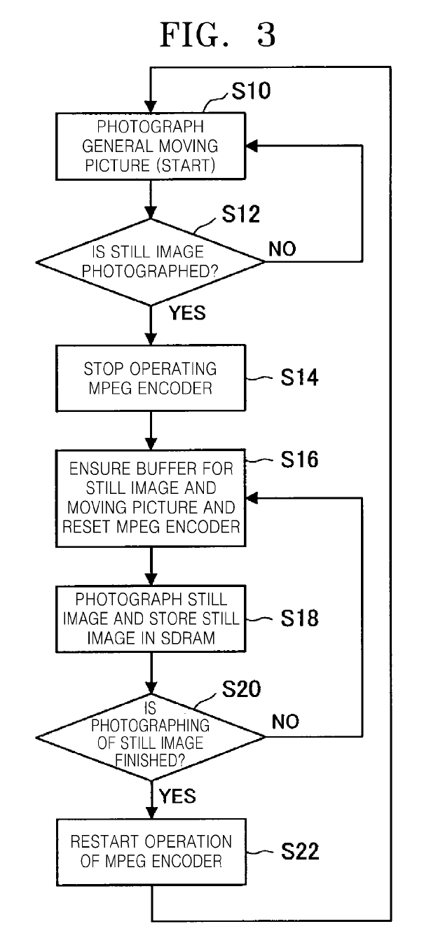

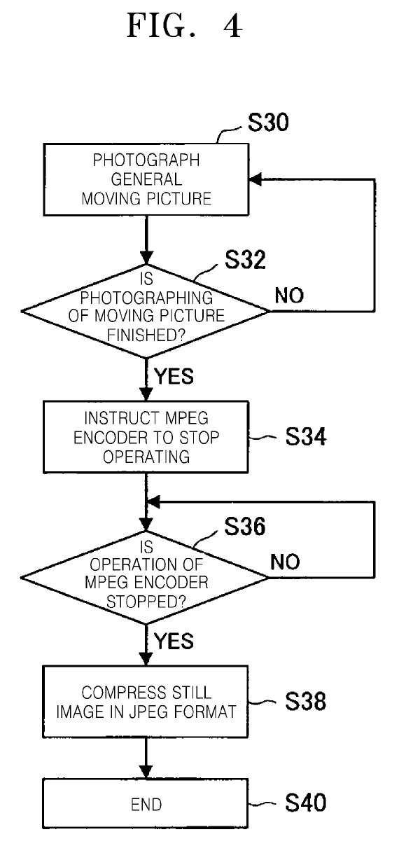

Next, operations of the photographing apparatus 100 will be described with reference to FIGS. 3 and 4. FIG. 3 is a flowchart illustrating processes when a still image is captured during recording of a motion picture. First, the recording of the motion picture starts in operation S10. Then, it is determined whether the still image is to be captured in operation S12. When the still image is to be captured, the process goes to operation S14, and the operation of the MPEG encoder 112 is stopped. In addition, when it is determined that a still image is not to be captured in operation S12, the process goes to operation S10.

After performing the operation S14, the process goes to operation S16. In operation S16, the SDRAM 126 ensures the buffers for the still image and the motion picture, and resets the MPEG encoder 112.

In operation S18, the still image is captured, and image data having a non-reduced number of pixels and output is stored in the SDRAM 126.

In operation S20, it is determined whether the capturing of the still image is finished. When the capturing of the still image is finished, the process goes to operation S22, and the operation of the MPEG encoder 112 restarts. On the other hand, when the capturing of the still image is not finished, the process goes to operation S16.

FIG. 4 is a flowchart illustrating processes when the recording of the motion picture is finished. In FIG. 4, operation S30 represents that recording of the motion picture is started. In operation S32, it is determined whether the recording of the motion picture is finished. When the recording of the motion picture is finished, the process goes to operation S34. In operation S34, the MPEG encoder 112 is instructed to stop operating after the encoding of the image frames of the motion picture accumulated in the buffer of the SDRAM 126 is finished. On the other hand, if the recording of the motion picture is not finished, the process goes to operation S30.

After performing the operation S34, the process determines whether the MPEG encoder 112 has stopped operating in operation S36. When the MPEG encoder 112 has stopped operating in operation S36, the process performs compression of the still image in the JPEG encoder 110 in operation S38. After performing operation S38, the process is finished. As described above, the compression of the still image by using the JPEG encoder 110 is performed after finishing the encoding of the motion picture by using the MPEG encoder 112, and thus, the accessible bandwidth of the SDRAM 126 may be ensured. On the other hand, if the MPEG encoder 112 has not stopped operating in operation S36, the process is in standby mode in operation S36.

As described above, when the still image is captured while recording the motion picture, the MPEG encoding of the motion picture is stopped, and then the MPEG encoding of the motion picture restarts after capturing the still image. Therefore, the accessible bandwidth of the SDRAM 126 may be ensured. Thus, the clock frequency of the memory such as the SDRAM 126 may be set to a minimum level, and power consumption may be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A photographing apparatus, comprising:
a motion picture data encoder for encoding image data of a motion picture that is output from an imaging device and processed by a frame unit when recording the motion picture;
a memory for storing image data of a still image output from the imaging device; and
a controller for storing the image data of the still image in the memory after stopping the encoding of the image data of the motion picture, when the still image is captured during recording of the motion picture,
wherein the controller restarts the encoding of the image data of the motion picture from an image frame at which the encoding is stopped during the capturing of the still image, and when the recording of the motion picture restarts after the capturing of the still image, a bayer interpolation unit interpolates the image data output from the imaging device when recording the motion picture, the memory includes buffers for the motion picture that store the image data after being interpolated, and the motion picture data encoder encodes the image data of the motion picture after being interpolated.

2. The photographing apparatus of claim 1, further comprising a still image data encoder encoding the image data of the still image,
wherein the controller control the still image data encoder to encode the image data of the still image after finishing the encoding of the image data of the motion picture, which is stopped due to the capturing of the still image.

3. The photographing apparatus of claim 1, wherein the memory stores the image data of the still image output from the imaging device as bayer data.

4. The photographing apparatus of claim 1, wherein the memory includes buffers for the motion picture that correspond to the number of image frames of the still images captured during recording of the motion picture.

5. The photographing apparatus of claim 1, wherein the memory includes buffers for the still images that correspond to the number of image frames of the still images captured during the recording of the motion picture.

6. A method of controlling a photographing apparatus, the method comprising:
outputting image data from an imaging device;
interpolating the image data and storing the result as motion picture data in a memory;
encoding the motion picture data in the memory;
determining if a request to take a still image is received;
when a request for a still image is received, substantially stopping the encoding of the motion picture data in the memory while continuing the outputting, interpolating and storing, and storing the image data in the memory as the still image; and
after storing the still image is complete, restarting the encoding of the motion picture data in the memory.

7. The method of claim 6, further comprising: encoding the still image after finishing the encoding of delayed motion picture data.

8. The method of claim 6, wherein storing the data output from the imaging device in the memory as the still image, comprises:
storing the data output from the imaging device in the memory as the still image in bayer data.

9. The method of claim 6, wherein the memory includes buffers large enough to accommodate motion picture data corresponding to the number of image frames of the still images captured during recording of the motion picture.

10. The method of claim 6, wherein the memory includes buffers large enough to accommodate a predetermined number of still images corresponding to the number of image frames of the still images captured during recording of the motion picture.

11. The method of claim 6, wherein restarting comprises:
restarting the encoding of the motion picture data in the memory at the same rate of compression as before the still image was captured.

12. The method of claim 6, further comprising:
compressing the still image with jpeg after the restarting the encoding of the motion picture data in the memory.

13. A photographing apparatus, comprising:
an imaging device configured to output image data;
a camera processor, configured to pass the image data to a bayer unit for capturing motion picture data when taking a moving picture, and configured to both pass the image data to a bayer unit and store the image data in a memory when taking a moving picture and capturing a still image;
the bayer unit, configured to interpolate the image data and store the result as motion picture data in the memory;
an mpeg encoder, configured to encode motion picture data stored in the memory;
the memory having a fixed bandwidth; and
a host CPU, configured to determine if a request to take a still image is received, and when a request for a still image is received, configured to substantially stop the mpeg encoder from encoding the motion picture data, and configured to control the imaging device to continue to output image data, and configured to control the camera processor to pass the image data to the bayer unit and to store the image data in the memory as the still image, and configured to control the bayer unit to interpolate the image data and store the result as motion picture data, and configured to control the mpeg encoder to continue to encode the motion picture data, after storing the still image is complete.
